(19) United States
(12) Patent Application Publication
(10) Pub. No.: US 2005/0107159 A1
(43) Pub. Date: May 19, 2005

(54) Game machine and program product for displaying demonstration video

(75) Inventor: Kazunobu Sato, Tokyo (JP)

Correspondence Address: MCGINN & GIBB, PLLC, 8321 OLD COURTHOUSE ROAD, SUITE 200, VIENNA, VA, 22182-3817, US

(73) Assignee: Aruze Corp., Tokyo (JP)

(21) Appl. No.: 10/959,298

(22) Filed: Oct. 7, 2004

(30) Foreign Application Priority Data
Oct. 9, 2003 (JP) P2003-351255

(51) Int. Cl. A63F 13/00

(52) U.S. Cl. 463/30

(57) ABSTRACT

A gaming machine includes: a demonstration video data storage unit that stores a plurality of demonstration video data of different types concerning demonstration video; a game history storage unit that stores a game history; a demonstration video data selection unit that selects at least one piece of demonstration video data from among the plurality of demonstration video data in accordance with the game history stored in the game history storage unit; and a display control unit that controls a display device attached to the gaming machine to display the demonstration video data that is selected by the demonstration video data selection unit when no game is played by a player.

### CROSS-REFERENCE TO THE RELATED APPLICATION(S)

This application is based upon and claims a priority from prior Japanese Patent Application No. 2003-351255 filed on Oct. 9, 2003, the entire contents of which are incorporated herein by reference.

### BACKGROUND OF THE INVENTION

1. Field of the Invention

This invention relates to a gaming machine installed in a place such as a video game arcade, and a program product for displaying a demonstration video.

2. Description of the Related Art

A conventional gaming machine, which is installed in a video game arcade, enables a player to enter the player's initials by operating an operation section after the game is over when the player earns a high score in a game, and the score ranking on which the entry is reflected is displayed. When no game is played, a logotype of a manufacturer of the game, a title screen, a game introduction movie, a character introduction movie, a computer simulation play, and the like are displayed on a display in addition to the score ranking.

The display when no game is played can produce the effects of raising the interest of a person who does not play a game in a game and making the player anxious to play a game and therefore a premium is placed on the advertising effectiveness. Hitherto, various schemes have been implemented to improve the pulling power of a video game arcade. For example, there is a gaming machine wherein the player earning a high score is photographed with a video camera and the photographed player image is displayed on a display together with the score ranking. (For example, refer to JP-A-11-239671) .

### SUMMARY OF THE INVENTION

However, in the gaming machine in the related art, demonstration video displayed on the display when no game is played is video data of a logotype of the manufacturer of the game, a title screen, a game introduction movie, a character introduction movie, a computer simulation play, and the like concatenated in a predetermined order, and such demonstration video is only displayed repeatedly every predetermined time. Thus, there is a problem that the demonstration video format is uniform and is poor in surprise and it is difficult to draw attention of persons who do not play a game.

In the gaming machine described in JP-A-11-239671, whenever the player image is photographed, the content of the demonstration video changes, but the configuration of the demonstration video remains uniform and tedious. Accordingly, there is a problem that such demonstration video is interesting demonstration video for the player whose image is displayed together with the score ranking, but cannot produce the effect of raising the interest in the game content and cannot demonstrate the sufficient advertising effectiveness for the persons who do not play a game.

Further, the demonstration video in the conventional gaming machine may raise the interest in a game of a person who have not yet played the game and may make the person anxious to play the game. Therefore, the conventional demonstration video may contribute to improvement in the pulling power of the video game arcade in gaining new players. However, it is difficult for the conventional demonstration video to raise new interest of a player who have already played the game and to make the player anxious to play another game for prompting the player to continue playing the game.

Particularly, in a game played by the player on his or her terminal over a communication line, such as an online game, to prompt the player to make the next entry, it is advantageous to give the demonstration video the unprecedented function of prompting the player to continue to play a game rather than the function of gaining new players as in the demonstration video in the related art.

It is therefore one of objects of the invention to provide a gaming machine and a program product to diversify demonstration video and improve the pulling power of a video game arcade and to prompt a player to continue playing the game.

According to a first aspect of the invention, there is provided a gaming machine including: a demonstration video data storage unit that stores a plurality of demonstration video data of different types concerning demonstration video; a game history storage unit that stores a game history; a demonstration video data selection unit that selects at least one piece of demonstration video data from among the plurality of demonstration video data in accordance with the game history stored in the game history storage unit; and a display control unit that controls a display device attached to the gaming machine to display the demonstration video data that is selected by the demonstration video data selection unit when no game is played by a player.

According to a second aspect of the invention, there is provided a gaming machine including: a video data storage unit that stores a plurality of video data of different types, the plurality of video data in which to be concatenated with each other to provide a demonstration video; a game history storage unit that stores a game history; a format data storage unit that stores a plurality of format data each indicating a format of the demonstration video; a format data selection unit that selects at least one piece of format data from among the plurality of format data in accordance with the game history stored in the game history storage unit; and a display control unit that replaces at least one piece of the video data that is concatenated with other pieces of the video data to form the demonstration video with another piece of the video data in accordance with the format data selected by the format data selection unit, and controls a display device attached to the gaming machine to display the demonstration video when no game is played by a player.

According to a third aspect of the invention, there is provided a computer-readable program product for displaying demonstration video on a display device when no game is played by a player, the program product for causing a computer to execute the steps including: storing a plurality of demonstration video data of different types concerning demonstration video; storing a game history; selecting at least one piece of demonstration video data from among the plurality of demonstration video data in accordance with the stored game history; and controlling a display device attached to the gaming machine to display the demonstration video data that is selected when no game is played by a player.

According to a fourth aspect of the invention, there is provided a computer-readable program product for displaying demonstration video on a display device when no game is played by a player, the program product for causing a computer to execute the steps including: storing a plurality of video data of different types, the plurality of video data in which to be concatenated with each other to provide a demonstration video; storing a game history; storing a plurality of format data each indicating a format of the demonstration video; selecting at least one piece of format data from among the plurality of format data in accordance with the game history; replacing at least one piece of the video data that is concatenated with other pieces of the video data to form the demonstration video with another piece of the video data in accordance with the selected format data; and controlling a display device attached to the gaming machine to display the demonstration video when no game is played by a player.

### BRIEF DESCRIPTION OF THE DRAWINGS

These and other objects and advantages of the present invention will be more fully apparent from the following detailed description taken in conjunction with the accompanying drawings, in which:

FIG. 1 is a perspective view to schematically show an example of a mahjong gaming machine 10 according to a first embodiment of the invention;

FIG. 2 is a plan view to schematically show an operation panel 14 of the mahjong gaming machine 10 according to the first embodiment;

FIG. 3 is a block diagram to schematically show the internal configuration of the mahjong gaming machine 10 according to the first embodiment;

FIG. 4 is a flowchart to show a game proceeding processing routine executed when a game is played in the mahjong gaming machine 10 according to the first embodiment;

FIG. 5 is a flowchart to show a demonstration video display processing routine executed when no game is played in the mahjong gaming machine 10 according to the first embodiment;

FIG. 6 is a drawing to show a demonstration video data selection table used at step S22 of the subroutine shown in FIG. 5;

FIG. 7 is a flowchart to show a demonstration video display processing routine executed when no game is played in a mahjong gaming machine 10 according to a second embodiment of the invention;

FIG. 8 is a drawing to show a format data selection table used at step S33 of the subroutine shown in FIG. 5;

FIG. 9 is a time chart to show the demonstration video format;

FIG. 10 is a time chart to show the demonstration video formats according to another embodiment of the invention;

FIG. 11 is a schematic drawing to show a computer for executing a program product according to the invention; and

FIG. 12 is a schematic drawing to show a game system for executing the program product according to the invention.

### DETAILED DESCRIPTION OF THE PREFERRED EMBODIMENTS

Referring now to the accompanying drawings, there is shown preferred embodiments of the invention.

In the invention, a demonstration video is video displayed on a screen of a gaming machine when no game is played by a player, and is implemented as concatenation of video data described later or demonstration video data. The video data is, for example, data of a logotype of the manufacturer of the game, a title screen, a game introduction movie, a character introduction movie, a computer simulation play movie, a score ranking of the game, and the like, and is, namely, data for one of video units different in video contents. The video data is not limited to the one exemplified above.

The demonstration video data is one of the video data or the video data concatenated in a predetermined order and a predetermined time allocation.

The demonstration video format includes two elements of: the order in which a plurality of pieces of video data are concatenated; and the display time of each piece of the video data.

### FIRST EMBODIMENT

A gaming machine of a first embodiment of the invention is a gaming machine including: a demonstration video data storage unit that stores a plurality of demonstration video data of different types concerning demonstration video; a game history storage unit that stores a game history; a demonstration video data selection unit that selects at least one piece of demonstration video data from among the plurality of demonstration video data in accordance with the game history stored in the game history storage unit; and a display control unit that controls a display device attached to the gaming machine to display the demonstration video data that is selected by the demonstration video data selection unit when no game is played by a player.

Hereinafter, the case where the invention is applied to a mahjong gaming machine for commercial use is shown as a gaming machine according to a first embodiment of the invention. However, the gaming machine of the invention is not limited to the gaming machine for commercial use and can also be applied to a consumer gaming machine and a portable gaming machine. The game played by the gaming machine is not limited to the mahjong game; for example, a shooting game, a so-called “beat'-em-up game”, a role-playing game, and the like, can be named.

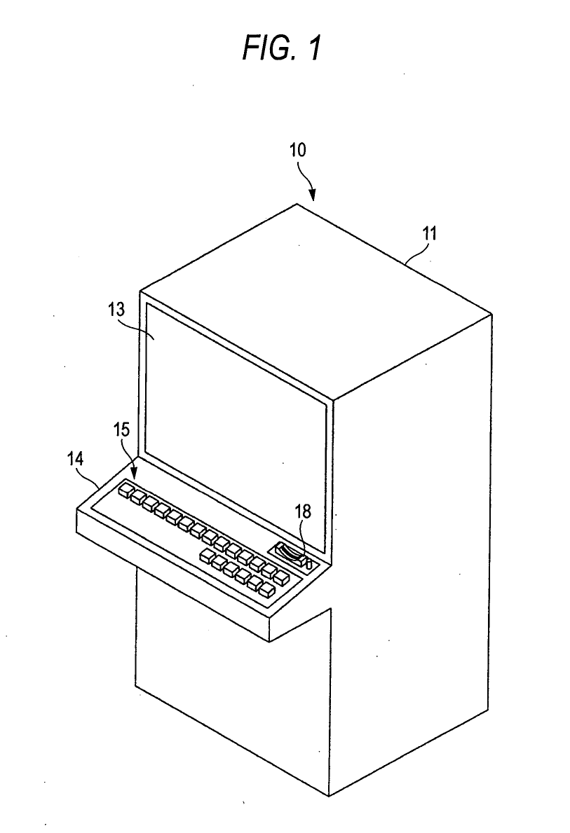

FIG. 1 is a perspective view to schematically show an example of a mahjong gaming machine according to the first embodiment of the invention.

A mahjong gaming machine 10 has a vertically oriented box-like cabinet 11 and is provided with a display 13 on the upper front of the cabinet 11.

When a game is played, the display 13 shows an image showing a mahjong table, an image showing 13 or 14 tiles of player-held tiles, an image showing player-discarded tile, an image showing the tiles held by an opponent character face down, an image showing tiles discarded by the opponent character, and the like. Further, the display 13 shows an image showing the player playing the mahjong game, an image showing the opponent character, and the like.

When no game is played by a player, the display 13 displays the score ranking, logotype of the manufacturer of the game, a title screen, a game introduction movie, a character introduction movie, a computer simulation play, and the like, as demonstration video.

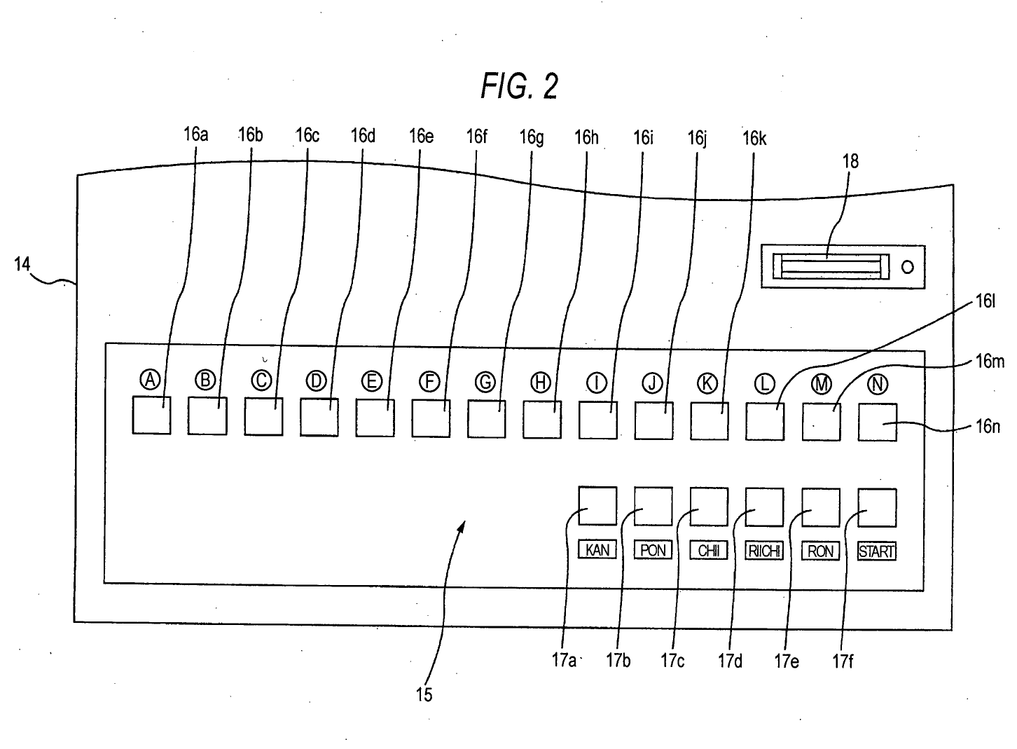

Below the display 13, an operation panel 14 provided with an operation section 15 thereon is provided so as to project toward the player. The operation section 15 includes 14 operation buttons placed at the far side of the operation panel 14 and six operation buttons placed at near side with respect to the 14 operation buttons. The player can perform various types of operation involved in a mahjong game by operating the operation buttons of the operation section 15. The operation section 15 is described later in detail with FIG. 2. A coin insertion slot 18 for inputting a coin required for starting a mahjong game is installed at the right end of the depth of the operation panel 14.

FIG. 2 is a plan view to schematically show the operation panel 14 of the mahjong gaming machine 10.

As shown in FIG. 2, the operation section 15 provided on the operation panel 14 includes 14 operation buttons 16 (16a to 16n) placed on the upper side of the operation panel 14 (depth in FIG. 1) and six operation buttons 17 (17a to 17f) placed below the 14 operation buttons (front in FIG. 1). The coin insertion slot 18 is provided above the right of the 14 operation buttons 16.

The 14 operation buttons 16 (16a to 16n) are provided in a one-to-one correspondence with the 14 tiles of player-held tiles displayed on the display 13. When the player holds 13 tiles, if the player presses the operation button 16n, a tile is picked up and a new tile is displayed at the right end of the 13 tiles displayed on the display 13 (at the position corresponding to the operation button 16n), resulting in 14 tiles held by the player. If the player selects an unnecessary tile from among the 14 tiles of the player-held tiles and presses the operation button 16 corresponding to the unnecessary tile, the tile is discarded and the unnecessary tile is erased from the player-held tiles, resulting in 13 tiles held by the player. The tile discarded as the unnecessary tile is newly displayed in the discarded tile display portion of the display 13.

The operation buttons 17a to 17e of the six operation buttons 17 (17a to 17f) correspond to “kan, ” “pon, ” “chii,” “riichi,” and “ron” in usual mahjong game, and the operation button 17f is a button pressed by the player to start a mahjong game after inputting a coin into the coin insertion slot 18.

As the player operates the operation section 15 made up of the operation buttons 16a to 16n and the operation buttons 17a to 17f, the player-held tiles are changed in order. On the other hand, an opponent character acts in a similar manner under the automatic control of a control section (CPU). Of course, the tiles of the opponent character are displayed face down and the player can see only the discarded tile of the opponent character.

The player and the opponent character repeat action of picking up a tile and action of discarding a tile alternately with action of “pon” and “chii,” or the like, inserted depending on the situation and when the player-held tiles become a combination corresponding to any of formed combinations (for example, “pinfu” and “tanyao”), accomplishment results and the gained points responsive to the formed combination resulting in the accomplishment can be obtained from the opponent character. On the other hand, if the opponent character achieves accomplishment and wins the game, the opponent character obtains the gained points responsive to the formed combination and the gained points of the player are decremented.

In the embodiment, as the player operates the operation buttons, the player-held tiles are changed in order. However, the mahjong gaming machine of the invention may be configured as follows: Display corresponding to the operation buttons is produced on the screen of the display and the player can perform the above-described operation by clicking the corresponding part with an input device.

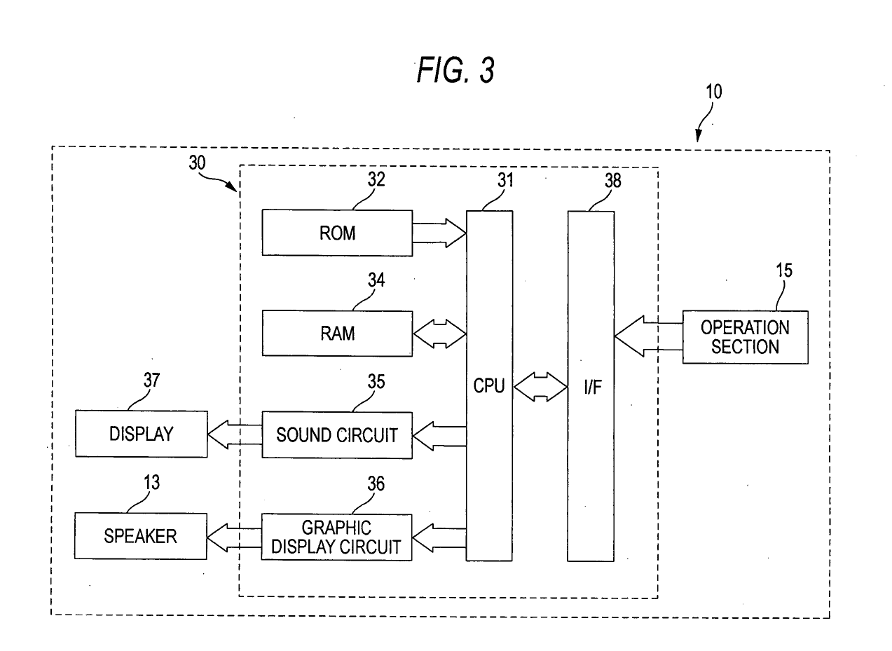

FIG. 3 is a block diagram to schematically show the internal configuration of the mahjong gaming machine 10.

As shown in FIG. 3, the cabinet 11 of the mahjong gaming machine 10 contains a control circuit 30. The control circuit 30 has a CPU (central processing unit) 31 of a control section, ROM (read-only memory) 32, and RAM (random access memory) 34.

The CPU 31 is connected to the operation section 15 via an interface circuit (I/F) 38. The CPU 31 performs various types of processing based on control signals from the operation section 15 and advances a mahjong game.

The ROM 32 stores various pieces of image data such as image data of the tiles and an opponent character displayed on the display 13 and a mahjong gaming machine control program for controlling the whole flow of a mahjong game. The ROM 32 also stores different types of demonstration video data concerning demonstration video. The different types of demonstration video data include data concerning logotype of the manufacturer of the game, a title screen, a game introduction movie, a character introduction movie, a computer simulation play, and the like, for example. The ROM 32 stores different types of game introduction movies, character introduction movies, computer simulation plays, and the like. The ROM 32 functions as demonstration video data storage unit in the mahjong gaming machine 10.

The ROM 32 also stores a demonstration video data selection table with a game history and demonstration video data associated with each other. The demonstration video data selection table is used to select demonstration video data from among the different types of demonstration video data.

The RAM 34 stores information concerning the issue of games against an opponent character and the data of the gained points gotten by the player in the games against the opponent character, the number of times the opponent character has achieved accomplishment, etc. Further, the RAM 34 stores the number of times each opponent character has been selected (the number of selection times) and the opponent character selection ratio (selection percentage) as the game history. The RAM 34 functions as game history storage unit in the mahjong gaming machine 10.

The demonstration video data need not necessarily be prestored in the ROM 32; for example, the video displayed on the display 13 during game execution may be stored in the RAM 34 as demonstration video data and when no game is played, the demonstration video data may be output to the display 13 for display. In this case, the RAM 34 functions as demonstration video data storage unit in the mahjong gaming machine 10.

A sound circuit 35 is connected to a speaker 37 for outputting various sounds responsive to the progress situation of a mahjong game. A graphic display circuit 36 displays an image selected by a control signal from the CPU 31 on the display 13.

In the mahjong gaming machine 10 described with reference to FIGS. 1 to 3, a game proceeds as follows: First, a player inputs a predetermined amount of gaming medium such as coins into the coin insertion slot 18 and operates the operation section 15, thereby starting a game. When the game is started, the player selects any one opponent character from among five opponent characters (characters A to E) and plays a mahjong game against the selected opponent character. If the player wins the game, it is possible for the player to continue to play a mahjong game, and another game proceeds starting at selecting any one opponent character. On the other hand, if the player loses the game, the game is over.

Next, processing of the mahjong gaming machine 10 according to the first embodiment of the invention will be discussed.

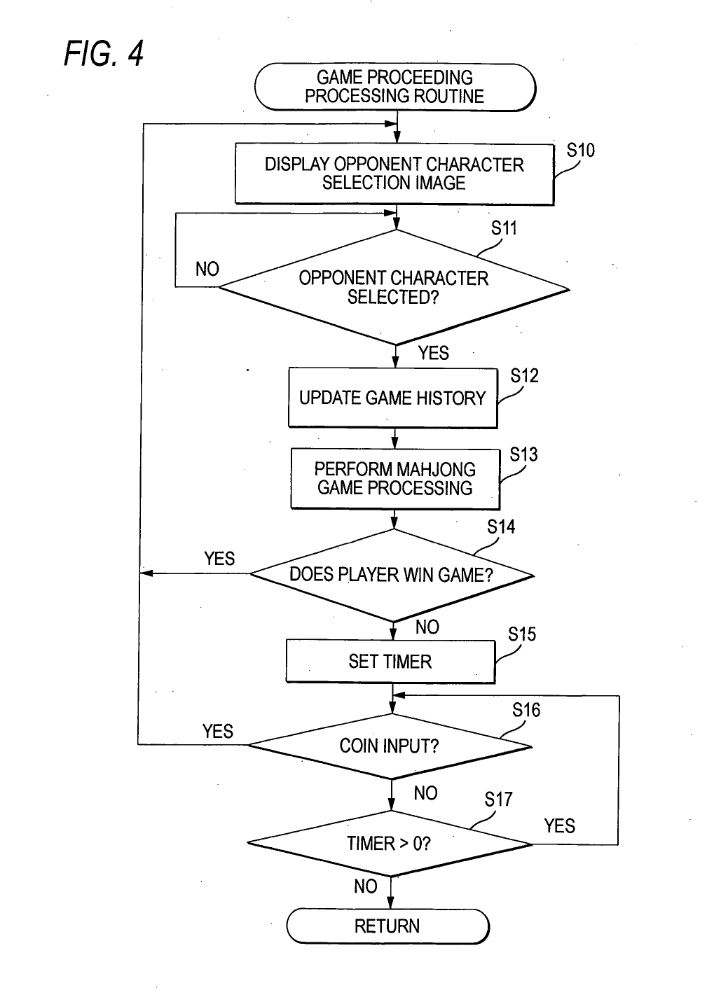

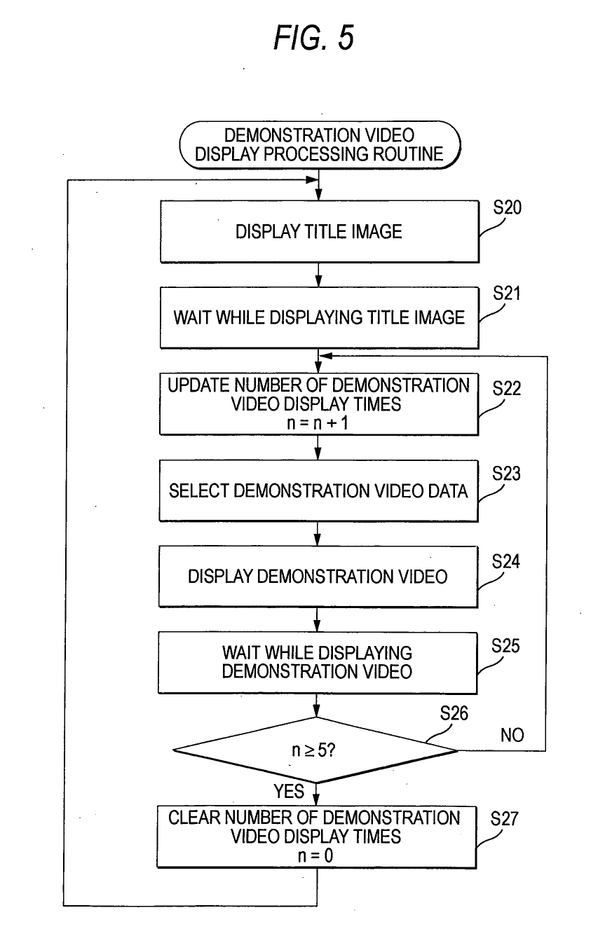

FIG. 4 is a flowchart to show a game proceeding processing routine executed when a game is played in the mahjong gaming machine 10. When a subroutine shown in FIG. 5 is executed, if a player inputs a predetermined amount of coins into the coin insertion slot 18 and operates the operation section 15 to enter a command for starting a game, the game proceeding processing subroutine is executed in the CPU 31 accordingly.

First, the CPU 31 causes the graphic display circuit 36 to display an opponent character selection image on the display 13 (step S10). The opponent character selection image contains an image showing the appearance, profiles, and the like, of five opponent characters (opponent characters A to E) and an image showing a command for prompting the player to select one of the five opponent characters. The player can select one opponent character by operating the operation section 15 in response to the prompt.

Next, the CPU 31 determines whether or not an opponent character has been selected (step S11). If the CPU 31 determines that an opponent character is not selected, the CPU 31 returns the process to step S11 and causes the graphic display circuit 36 to continue displaying the opponent character selection image.

When an opponent character is selected, the CPU 31 updates the number of selection times and the selection percentage of the opponent character stored in the RAM 34 (step S12). The number of selection times and the selection percentage of the opponent character are calculated for each opponent character and are stored in the RAM 34 as a game history.

Next, the CPU 31 performs mahjong game processing (step S13). In a mahjong game, the player and the opponent character are given each predetermined gained points (for example, 10000 points) at the game play start time and if the gained points of the opponent character become zero or the player achieves three accomplishments, the player wins the game and the game is over. In contrast, if the gained points of the player become zero because the opponent character achieves accomplishments, etc., the opponent character wins the game and the game is over. At step S13, the CPU 31 performs computation processing associated with game advance and further causes the graphic display circuit 36 to display an image on the display 13 and the sound circuit 35 to output sound, etc., from speaker 37 based on the computation result. The processing at step S13 terminates when the game is over.

After performing the processing at step S13, the CPU 31 determines whether or not the player wins the game (step S14) If the CPU 31 determines that the player wins the game, the CPU 31 returns the process to step S10 and executes steps S10 to S13.

On the other hand, if the CPU 31 determines at step S14 that the player does not win the game, the CPU 31 sets a timer (step S15). The timer counts the time until the game is over; for example, it is set to 20 seconds.

Next, the CPU 31 determines whether or not the player has input a predetermined amount of coins into the coin insertion slot 18 (step S16). If the CPU 31 determines that the player has input the predetermined amount of coins, the CPU 31 returns the process to step S10 and executes steps S10 to S13. On the other hand, if the CPU 31 determines that the player does not input coins, the CPU 31 determines whether or not the remaining time of the timer exists (step S17). If the remaining time of the timer exists, the CPU 31 returns the process to step S16. If the CPU 31 determines at step S17 that the remaining time of the timer does not exist, it unit that no coins have been input within the setup time and therefore the game is over and the subroutine is exited.

FIG. 5 is a flowchart to show a demonstration video display processing routine executed when no game is played in the mahjong gaming machine 10.

This subroutine is a subroutine executed in the CPU 31 when power of the mahjong gaming machine 10 is turned on.

When the subroutine shown in FIG. 5 is executed, if a player inputs a predetermined amount of coins into the coin insertion slot 18 and operates the operation section 15 to enter a command for starting a game, the CPU 31 exits the subroutine and executes the subroutine previously described with reference to FIG. 4 and then when the CPU 31 exits the subroutine in FIG. 4, again the CPU 31 executes the subroutine shown in FIG. 5.

When the subroutine shown in FIG. 5 is called, first the CPU 31 causes the graphic display circuit 36 to display a title image on the display 13 (step S20) and then waits until the expiration of a predetermined time interval (step S21).

Next, the CPU 31 updates the number of demonstration video display times (n) stored in the RAM 34 as n=n+1 and stores the updated number in the RAM 34 (step S22).

The number of demonstration video display times is the number of times demonstration video data has been displayed, and the initial value (the value when the subroutine is started) is 0. The number of demonstration video display times (n) is incremented by one each time the loop of steps S22 to S26 is executed until it is determined that n³5 at step S26 after steps S22 to S26 are executed repeatedly.

Next, the CPU 31 selects demonstration video data responsive to the game history stored in the RAM 34 based on the demonstration video data selection table stored in the ROM 32 (step S22). At this time, the CPU 31 functions as demonstration video data selection unit.

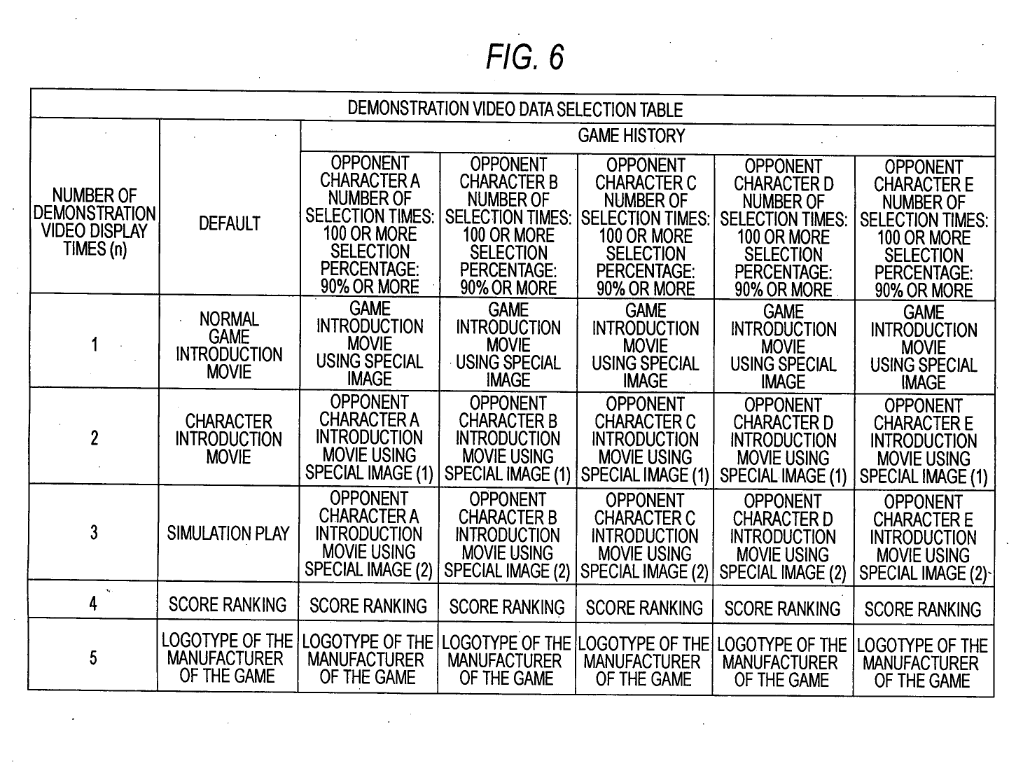

FIG. 6 is a drawing to show an example of the demonstration video data selection table.

The demonstration video data corresponding to the number of demonstration video display times (n) and the game history is set in the demonstration video data selection table. Specifically, as default demonstration video, “normal game introduction movie” is set as n=1; “character introduction movie” is set as n=2; “computer simulation play” is set as n=3; “score ranking” is set as n=4; and “logotype of the manufacturer of the game ” is set as n=5 in the demonstration video data selection table.

As the demonstration video data when the number of selection times of character A is 100 or more and the selection percentage is 90% or more, “game introduction movie using special image” is set as n=1; “opponent character A introduction movie using special image” is set as n=2, 3; “score ranking” is set as n=4; and “logotype of the manufacturer of the game ” is set as n=5. Herein, the special image is an image not contained in the default demonstration video. That is, the “game introduction movie using special image” contains an image not contained in the default “normal game introduction movie” and the “opponent character A introduction movie using special image” contains an image not contained in the default “character introduction movie.” In the demonstration video data selection table, the demonstration video data is also set for opponent characters B to E like opponent character A.

If the game history indicating that the number of selection times of any of characters A to E is 100 or more and the selection percentage is 90% or more is stored in the RAM 34, the “game introduction movie using special image” or the “opponent character introduction movie using special image” is selected at step S23. On the other hand, if the game history stored in the RAM 34 does not satisfy the above-described conditions, the default demonstration video data is selected at step S23.

After selecting the demonstration video data at step S23 of the subroutine shown in FIG. 5, the CPU 31 causes the graphic display circuit 36 to output the demonstration video data to the display 13 for displaying the demonstration video thereon. At this time, the CPU 31 functions as display control unit.

After this, the CPU 31 waits until the expiration of a predetermined time interval (step S25) and continues displaying the demonstration video on the display 13. Next, the CPU 31 determines whether or not the number of demonstration video display times (n) stored in the RAM 34 is n≧5 (step S26). If the CPU 31 does not determine that the number of demonstration video display times (n) is n≧5, the CPU 31 returns the process to step S22 and again executes steps S22 to S26. Consequently, different demonstration video is displayed.

If the CPU 31 determines that the number of demonstration video display times (n) is n≧5, the CPU 31 resets the number of demonstration video display times (n) stored in the RAM 34 as n=0 (step S27) and returns the process to step S20. Consequently, the title image is displayed on the display 13 and then demonstration video is displayed.

Thus, according to the mahjong gaming machine 10 according to the first embodiment of the invention, the demonstration video changes in accordance with the game history, so that it is possible to draw attention of persons who do not play a game, and demonstration video which is rich in surprise and can demonstrate the sufficient advertising effectiveness can be displayed. Consequently, the interest of a person who does not play a game in a game can be raised and the person can be made anxious to play a game; it is made possible to improve the pulling power of the video game arcade.

For example, if the number of selection times of opponent character A is 100 or more and the selection percentage is 90% or more, the game introduction movie using a special image or the opponent character A introduction movie using a special image is displayed as the demonstration video, so that new interest of the player who once played a game can be raised and the player can be made anxious to play another game for prompting the player to continue to play a game.

### SECOND EMBODIMENT

A gaming machine according to a second embodiment of the invention is a gaming machine including: a video data storage unit that stores a plurality of video data of different types, the plurality of video data in which to be concatenated with each other to provide a demonstration video; a game history storage unit that stores a game history; a format data storage unit that stores a plurality of format data each indicating a format of the demonstration video; a format data selection unit that selects at least one piece of format data from among the plurality of format data in accordance with the game history stored in the game history storage unit; and a display control unit that replaces at least one piece of the video data that is concatenated with other pieces of the video data to form the demonstration video with another piece of the video data in accordance with the format data selected by the format data selection unit, and controls a display device attached to the gaming machine to display the demonstration video when no game is played by a player.

Demonstration video in a gaming machine according to the second embodiment of the invention is provided by concatenating a plurality of pieces of video data and is not implemented as signal video data unlike the demonstration video in the gaming machine of the first embodiment.

The appearance and the internal configuration of a mahjong gaming machine 10 according to the second embodiment of the invention are roughly similar to those of the mahjong gaming machine 10 according to the first embodiment (see FIGS. 1 to 3) except that ROM 32 previously stores format data concerning the configurations of different types of video data and demonstration video, and have been already described and therefore will not be discussed again and components identical with or similar to those of the mahjong gaming machine 10 according to the first embodiment previously described with reference to FIGS. 1 to 3 are denoted by the same reference numerals.

Game proceeding processing of the mahjong gaming machine according to the second embodiment is similar to the game proceeding processing of the mahjong gaming machine 10 according to the first embodiment previously described with reference to FIG. 4 and therefore will not be discussed again. Demonstration video display processing of the mahjong gaming machine according to the second embodiment will be discussed.

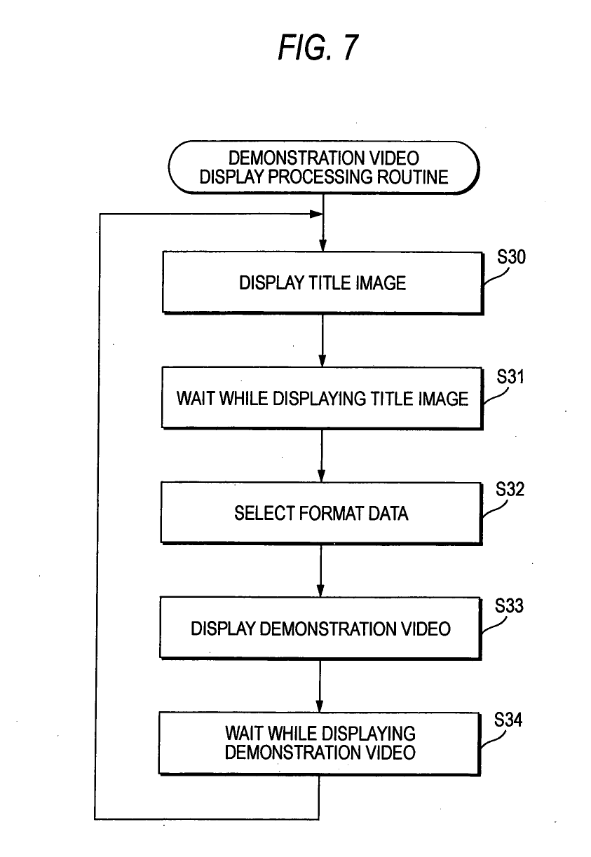

FIG. 7 is a flowchart to show a demonstration video display processing routine executed when no game is played in the mahjong gaming machine 10 according to the second embodiment.

This subroutine is a subroutine executed in a CPU 31 when power of the mahjong gaming machine 10 is turned on. When the subroutine shown in FIG. 7 is executed, if a player inputs a predetermined amount of coins into a coin insertion slot 18 and operates an operation section 15 to enter a command for starting a game, the CPU 31 exits the subroutine and executes the subroutine previously described with reference to FIG. 4 and then when the CPU 31 exits the subroutine in FIG. 4, again the CPU 31 executes the subroutine shown in FIG. 7.

When the subroutine shown in FIG. 7 is called, first the CPU 31 causes a graphic display circuit 36 to display a title image on a display 13 (step S30) and then waits until the expiration of a predetermined time interval (step S31).

Next, the CPU 31 selects the format data responsive to the game history stored in RAM 34 based on a format data selection table stored in the ROM 32 (step S32). At this time, the CPU 31 functions as format data selection unit.

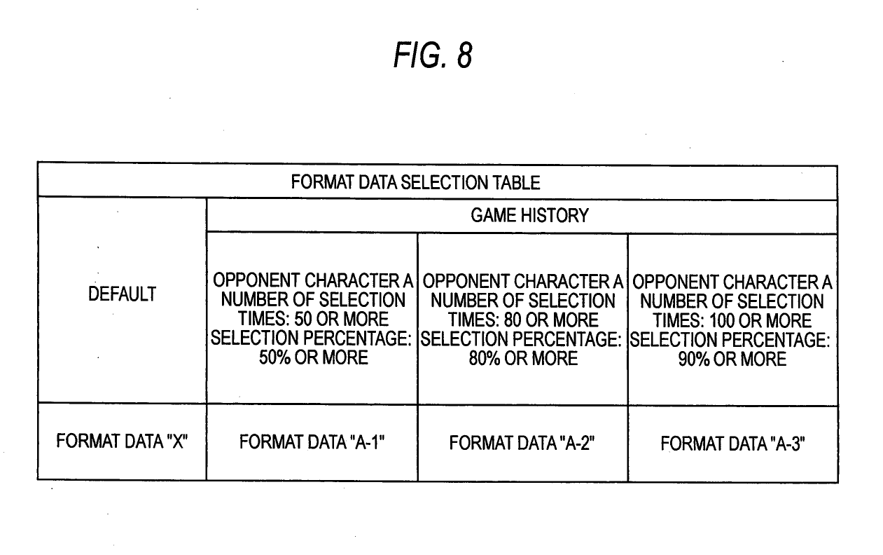

FIG. 8 is a drawing to show an example of the format data selection table. FIG. 8 shows the relationship between the game history and the format data when the game history about opponent character A satisfies predetermined conditions; the data is also set for opponent characters B to E like opponent character A.

In the format data selection table, “X” is set as default format data; “A-1” is set as format data when the number of selection times of opponent character A is 50 or more and the selection percentage is 50% or more; “A-2” is set as format data when the number of selection times of opponent character A is 80 or more and the selection percentage is 80% or more; and “A-3” is set as format data when the number of selection times of opponent character A is 100 or more and the selection percentage is 90% or more.

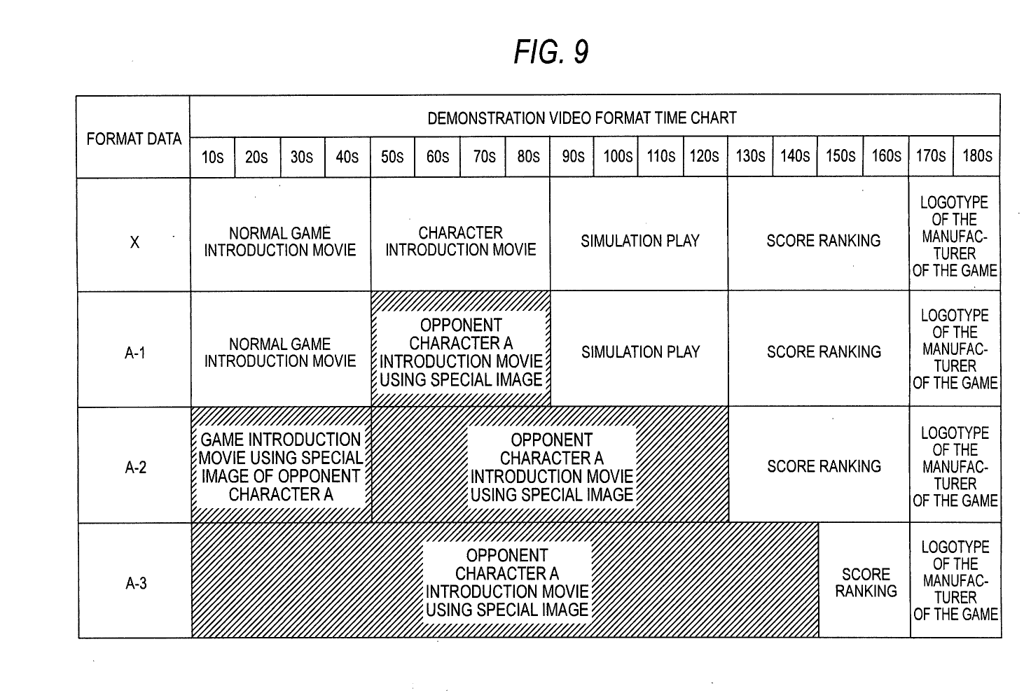

After selecting the format data at step S32 of the subroutine shown in FIG. 7, the CPU 31 causes the graphic display circuit 36 to output video data to the display 13 in the video data order and the time allocation shown in FIG. 9 in accordance with the demonstration video format contained in the format data for displaying demonstration video on the display 13 (step S33)

FIG. 9 is a time chart to show the demonstration video format.

If the format data is “X,” the default demonstration video format is set so as to display “normal game introduction movie” in the time slot of 0 to 40 seconds, “character introduction movie” in the time slot of 40 to 80 seconds, “computer simulation play” in the time slot of 80 to 120 seconds, “score ranking” in the time slot of 120 to 160 seconds, and “logotype of the manufacturer of the game ” in the time slot of 160 to 180 seconds.

If the format data “X” is selected at step S32, the CPU 31 goes to step S33 and outputs the video data to the display 13 in order according to the default configuration for displaying demonstration video on the display 13.

If the format data is “A-1,” the demonstration video format is set so as to display “normal game introduction movie” in the time slot of 0 to 40 seconds, “opponent character A introduction movie using special image” in the time slot of 40 to 80 seconds, “computer simulation play” in the time slot of 80 to 120 seconds, “score ranking” in the time slot of 120 to 160 seconds, and “logotype of the manufacturer of the game ” in the time slot of 160 to 180 seconds.

That is, the “character introduction movie” in the time slot of 40 to 80 seconds in the default demonstration video format is replaced with the “opponent character A introduction movie using special image.”

Therefore, if the format data “A-1” is selected at step S32, the CPU 31 replaces the “character introduction movie” forming a part of the default demonstration video with the “opponent character introduction movie using special image” and outputs the video data to the display 13 in order for displaying demonstration video on the display 13.

If the format data is “A-2,” the demonstration video format is set so as to display “game introduction movie using special image of opponent character A” in the time slot of 0 to 40 seconds, “opponent character A introduction movie using special image” in the time slot of 40 to 120 seconds, “score ranking” in the time slot of 120 to 160 seconds, and “logotype of the manufacturer of the game ” in the time slot of 160 to 180 seconds.

That is, the “normal game introduction movie” in the time slot of 0 to 40 seconds in the default demonstration video format is replaced with the “game introduction movie using special image of opponent character A” and the “character introduction movie” and the “computer simulation play” in the time slot of 40 to 120 seconds are replaced with the “opponent character A introduction movie using special image.”

Therefore, if the format data “A-2” is selected at step S32, the CPU 31 replaces the “normal game introduction movie” forming a part of the default demonstration video with the “game introduction movie using special image of opponent character A” and replaces the “character introduction movie” and the “computer simulation play” with the “opponent character introduction movie using special image” and outputs the video data to the display 13 in order for displaying demonstration video on the display 13.

If the format data is “A-3,” the demonstration video format is set so as to display “opponent character A introduction movie using special image” in the time slot of 0 to 140 seconds, “score ranking” in the time slot of 120 to 160 seconds, and “logotype of the manufacturer of the game ” in the time slot of 160 to 180 seconds. That is, the part in the time slot of 0 to 140 seconds in the default demonstration video format is replaced with the “opponent character A introduction movie using special image.”

Therefore, if the format data “A-3” is selected at step S32, the CPU 31 replaces the video data part in the time slot of 0 to 140 seconds forming a part of the default demonstration video with the “opponent character A introduction movie using special image” and outputs the video data to the display 13 in order for displaying demonstration video on the display 13.

When executing step S33, the CPU 31 replaces any of a plurality of pieces of the video data forming the demonstration video with any other video data based on the selected format data and outputs the data to the display 13, whereby the CPU 31 functions as display control unit for performing display control of the demonstration video. After starting step S33, the CPU 31 waits until termination of display of the demonstration video based on the format data (step S33) and then returns the process to step S30.

Thus, according to the mahjong gaming machine 10 according to the second embodiment of the invention, the demonstration video format changes in accordance with the game history, so that it is possible to draw attention of persons who do not play a game, and demonstration video which is rich in surprise and can demonstrate the sufficient advertising effectiveness can be displayed. Consequently, the interest of a person who does not play a game in a game can be raised and the person can be made anxious to play a game; it is possible to improve the pulling power of the video game arcade.

For example, if the number of selection times of opponent character A is a predetermined number or more and the selection percentage is a predetermined value or more, the demonstration video format changes in accordance with the game history in such a manner that the display part of the opponent character introduction movie in the demonstration video is replaced with the character introduction movie using the special image of opponent character A, so that the player who once played a game can be made anxious to play another game for prompting the player to continue to play a game.

In the gaming machines 10 according to the first and second embodiments, the number of opponent character selection times and the selection percentage are stored as the game history, but the game history in the invention is not limited; for example, a time period of playing the game, a number of persons (characters) won by the player, a winning condition won by the player (e.g. winning combination), a game point won by the player (including the average points, the highest points, the lowest points, and the like, of the gained points at the winning time) can be named as the items contained in the game history.

Such a game history may be accumulated from once turning on the power of the mahjong gaming machine to stopping of the power supply as with the gaming machine of the first and the second embodiment, or may be stored for each of a plurality of players.

For example, the following method can be used for storing the game history for each player: When a game is started or is over, the ID code unique to a player is given to the player and when the player again plays a game, the player is requested to enter the ID code or the ID code is read. If the player continues playing a game, the game history concerning the player in the game history stored for each player is updated for storage. To thus store the game history for each player, it is made possible for each player to enjoy seeing the demonstration video on which his or her game history is reflected without allowing other persons to see the demonstration video, so that the interest of the player in the game can be raised for strongly prompting the player to continue to play the game.

In the gaming machines 10 according to the first and second embodiments, demonstration video is displayed on the display 13 after the termination of counting the time until the game is over after the player loses the game. However, in the invention, demonstration video may be displayed on the display 13 while the time until the game is over is counted with the player losing the game.

To do this, it is desirable that the game history should be accumulated in the RAM 34 so long as the player inputs a coin into the coin insertion slot 18 for continuing to play another game while the time until the game is over is counted with the player losing the game and that the game history should be reset at the termination of counting the time until the game is over. Thus, it is made possible for the player to enjoy seeing the demonstration video on which his or her game history is reflected without allowing other persons to see the demonstration video, so that the interest of the player in the game can be raised for strongly prompting the player to continue to play the game.

In the invention, the following configuration can be adopted:
(A) A gaming machine wherein when no game is played, demonstration video provided by concatenating a plurality of pieces of video data is displayed on a display, the gaming machine including:
   game history storage unit for storing a game history; and
   display control unit for performing display control of the demonstration video, characterized in that
   if the game history stored in the game history storage unit is a specific game history, the display control unit performs display control of the demonstration video so as to output display based on specific video data contained in the demonstration video more than once to the display while one demonstration video is output to the display.

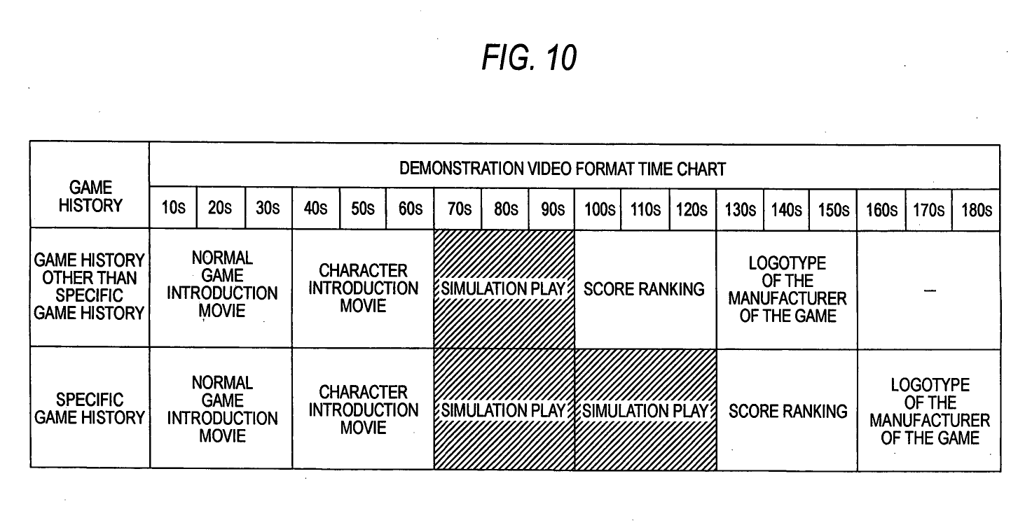

In the gaming machine having the configuration of (A), a game history similar to that in the first and the second embodiment can be named. The game history is stored in a similar manner to that in the first and the second embodiment. When the demonstration video display timing on the display is reached, whether or not the game history becomes a specific game history is determined, and video data is output to the display in the video data order and the time allocation shown in FIG. 10 in response to the determination result for displaying demonstration video on the display.

The specific game history is not limited; for example, a game history to the effect that the number of selection times of opponent character A is 100 or more and the selection percentage is 90% or more or the like can be named.

FIG. 10 is a time chart to show the demonstration video data configurations in the gaming machine having the configuration of (A).

If the game history is any other game history than the specific game history, the display time of one demonstration video is 150 seconds and the demonstration video format is set so as to display “normal game introduction movie” in the time slot of 0 to 30 seconds, “character introduction movie” in the time slot of 30 to 60 seconds, “computer simulation play” in the time slot of 60 to 90 seconds, “score ranking” in the time slot of 90 to 120 seconds, and “logotype of the manufacturer of the game ” in the time slot of 120 to 150 seconds.

Therefore, in the gaming machine having the configuration of (A), if the game history is any other game history than the specific game history, the display control unit performs display control of demonstration video on the display so as to output display based on each video data contained in the demonstration video to the display while one demonstration video is output to the display.

On the other hand, if the game history is the specific game history, the display time of one demonstration video is 180 seconds and the demonstration video format is set so as to display “normal game introduction movie” in the time slot of 0 to 30 seconds, “character introduction movie” in the time slot of 30 to 60 seconds, “computer simulation play” in the time slot of 60 to 90 seconds, again “computer simulation play” in the time slot of 90 to 120 seconds, “score ranking” in the time slot of 120 to 150 seconds, and “logotype of the manufacturer of the game ” in the time slot of 150 to 180 seconds.

Therefore, in the gaming machine having the configuration of (A), if the game history is the specific game history, the display control unit performs display control of demonstration video on the display so as to output display based on specific video data contained in the demonstration video (in the example, the video data concerning “computer simulation play”) more than once to the display while one demonstration video is output to the display.

Thus, according to the gaming machine having the configuration of (A), if the game history becomes the specific game history, display based on the specific video data contained in the demonstration video is output to the display more than once, so that the specific video data is repeatedly output to the display while the demonstration video format is changed in accordance with the game history, whereby attention of persons who do not play a game can be drawn. Consequently, the interest of a person who does not play a game in a game can be raised and the person can be made anxious to play a game; it is made possible to improve the pulling power of the video game arcade. Since the demonstration video responsive to the game history is displayed, the player who once played a game can be made anxious to play another game for prompting the player to continue to play a game.

In the gaming machine having the configuration of (A), if the game history is the specific game history, it is desirable that the “computer simulation play” as the specific video data should contain a special image showing a character not appearing if the game history is any other game history than the specific game history, because the demonstration video can be more diversified and strong interest can be attracted from the player.

In this case, display based on the video data of the “computer simulation play” is output to the display more than once, but all “computer simulation plays” need not be the same and, for example, only the “computer simulation play” displayed at a specific time may contain a special image.

In the gaming machine having the configuration of (A), it is desirable that whether or not video data containing a special image is used for the “computer simulation play” if the game history is the specific game history should be determined by lottery (special lottery), that whether or not video data containing a special image is used for the “computer simulation play” if the game history is any other game history than the specific game history should be determined by lottery (ordinary lottery), and that the winning probability in the special lottery should be set higher than that in the ordinary lottery, because the demonstration video can be more diversified and strong interest can be attracted from persons who do not play a game.

When display based on the video data of the “computer simulation play” is output to the display more than once, it is desirable that whether or not video data containing a special image is used for the “computer simulation play” displayed at a specific time should be determined by lottery, that whether or not video data containing a special image is used for the “computer simulation play” displayed at any other time than the specific time should be determined by lottery, and that the winning probability in the former lottery should be made different from that in the latter lottery, because the demonstration video can be more diversified and strong interest can be attracted from persons who do not play a game.

The ROM 32 of the mahjong gaming machine 10 according to the first, second embodiment as described above stores a program of the invention for causing the mahjong gaming machine 10 to function as the various unit described above. The program of the invention may be used with a personal computer, a consumer gaming machine, a portable gaming machine, and the like, for example.

The program product for causing a computer to function as the various unit of the mahjong gaming machine 10 according to the first embodiment will be discussed below:

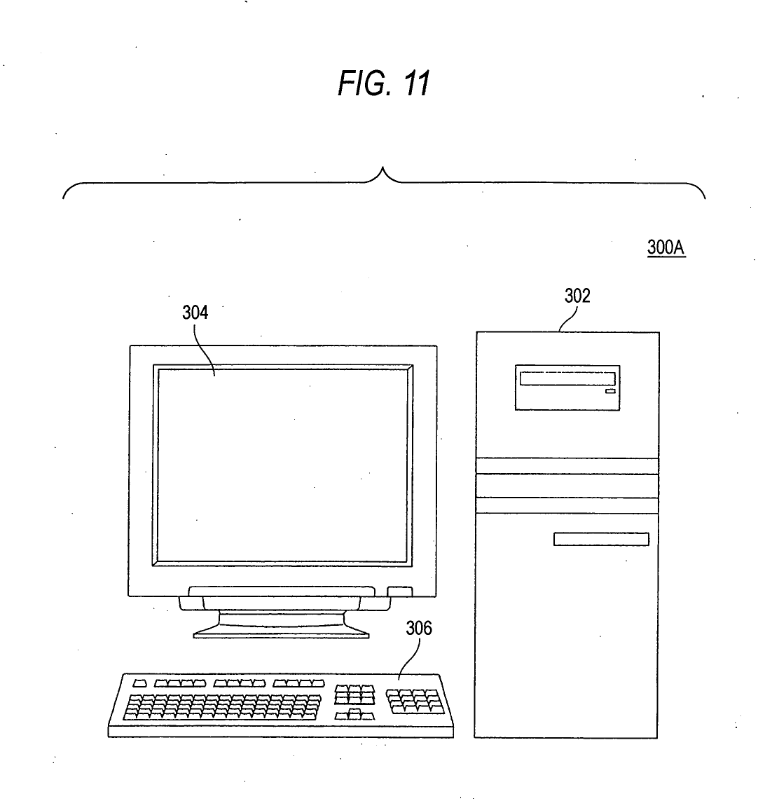

FIG. 11 is a schematic drawing to show a computer for executing the program according to the invention.

A computer 300A includes a computer main unit 302, a display 304, and a keyboard 306 as an operation section. The display 304 and the keyboard 306 are electrically connected to the computer main unit 302. In the embodiment, the keyboard 306 is provided as the operation section, but the invention is not limited to it; any other component, such as a mouse or a computer, may be adopted if it can be operated.

The computer main unit 302 contains a control circuit (not shown). This control circuit includes a storage section (not shown) for storing various pieces of data, various programs, etc., and a drive (not shown) for reading data from a storage medium that can be inserted into and detached from the computer 300A, such as a CD-ROM, a DVD-ROM, or a ROM cartridge. The control circuit also includes an interface circuit (not shown) for controlling external units of the display 304, the keyboard 306, etc.

In the embodiment, a personal computer is used as the computer, but the invention is not limited to the mode. For example, a portable terminal such as a mobile telephone or a PDA (Personal Digital Assistant) may be adopted.

In the embodiment, the program is stored in a storage medium such as a CD-ROM, a DVD-ROM, or a ROM cartridge, and the control section executes various types of processing in accordance with the program.

In the embodiment, the program product for causing the computer (control section) to function as the various unit of the mahjong gaming machine 10 according to the first embodiment will be discussed. Specifically, the program product causes the computer to execute the following processing (steps):
(A-1) Demonstration video storage processing of storing different types of demonstration video data concerning the demonstration video in a storage section;
(A-2) game history storage processing of storing a game history in the storage section;
(A-3) demonstration video data selection processing of selecting any demonstration video data from among the different types of demonstration video data in accordance with the game history stored in the storage section; and
(A-4) display control processing of outputting the selected demonstration video data to the display, thereby performing display control of the demonstration video.

Thus, the computer is caused to execute the processing (A1) to (A4), whereby the interest of a person who does not play a game in a game can be raised and the person can be made anxious to play a game; it is made possible to improve the pulling power of the video game arcade. Since the demonstration video responsive to the game history is displayed, the player who once played a game can be made anxious to play another game for prompting the player to continue to play a game.

In the embodiment, the control section is caused to function as various unit in accordance with the program stored in a storage medium that can be inserted into and detached from the computer 300A, such as a CD-ROM, a DVD-ROM, or a ROM cartridge, but the invention is not limited to the mode. The control section may be caused to function as various unit in accordance with the program stored in the storage section incorporated in the computer 300A.

In the embodiment, one computer 300A executes various types of processing, but the invention is not limited to the mode. The various types of processing may be shared between the computer and a different computer (for example, a game server, etc.,).

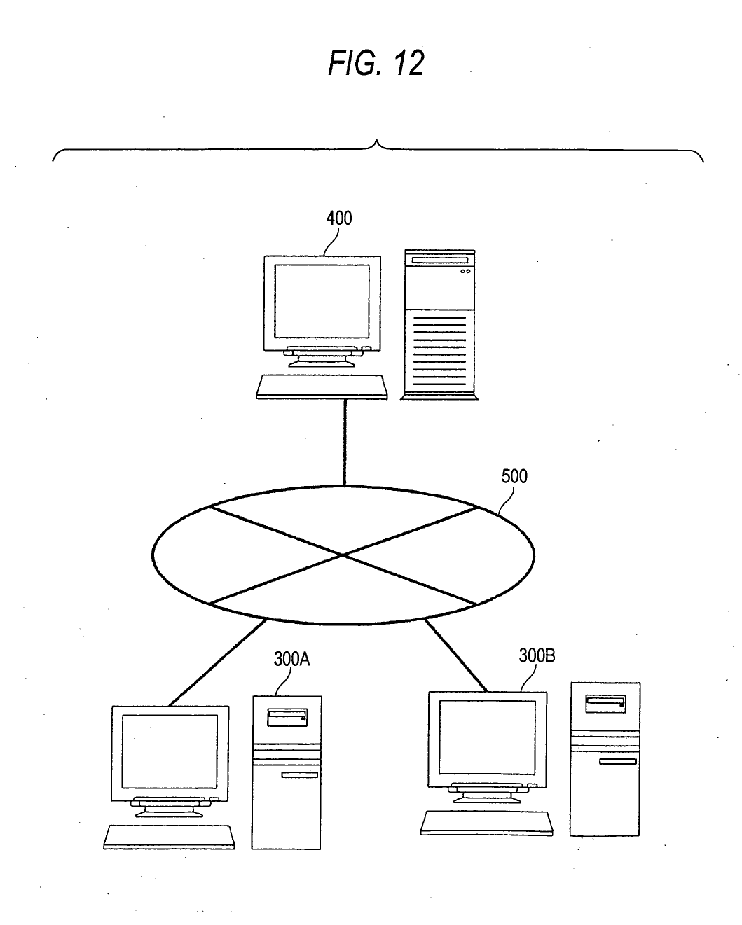

Next, a program product executed by using a different computer will be discussed with FIG. 12.

FIG. 12 is a schematic drawing to show a game system for executing the program product according to the invention.

As shown in FIG. 12, computers 300A, 300B, . . . and a game server 400 of a different computer are connected to a network 500. This unit that the computers 300A, 300B, . . . are connected so that they can communicate with the game server 400. The game server 400 includes a control section (not shown) and a storage section (not shown) for storing the program. The control section executes various types of processing in accordance with the program stored in the storage section.

In this case, the specifically described processing in the embodiment may be shared among the computers 300A, 300B, . . . and the game server 400.

As an example of the program product for providing the mahjong game in the embodiment, the program product for executing the processing (A1) and (A3) described above is stored in the storage section of the game server 400 and the program for executing the processing (A2) and (A4) described above is stored in the storage section of the computer 300A, 300B, . . . Accordingly, the control section of the game server 400 executes the processing (A1) and (A3) and the control section of the computer 300A, 300B, . . . executes the processing (A2) and (A4).

In doing so, as the demonstration video data stored in the storage section of the game server 400 is updated, the demonstration video in the computer 300A, 300B, . . . can be updated, so that the most recent demonstration video can always be presented to the player and new interest of the player can be raised and the player can be made anxious to play another game for prompting the player to continue to play a game.

In the embodiment, the computers 300A, 300B, . . . and the game server 400 are caused to execute various types of processing contained in the program, but the invention is not limited to the mode. The program for executing various types of processing may be stored in the game server 400 and the game server 400 may cause the computer 300A, 300B, . . . to execute the program in response to a download request sent from the computer 300A, 300B, . . . to the game server 400.

Next, a program for causing a computer to function as the various unit of the mahjong gaming machine 10 according to the second embodiment will be discussed. Specifically, the program causes the computer to execute the following processing (steps):
(B1) Video data storage processing of storing different types of video data in a control section.
(B2) Format data storage processing of storing different types of format data concerning the demonstration video format in a control section.
(B3) Game history storage processing of storing a game history.
(B4) Format data selection processing of selecting any one format data from among the different types of format data stored in the storage section in accordance with the game history stored in the storage section.
(B5) Display control processing of replacing any of a plurality of pieces of video data forming the demonstration video with any other video data based on the selected format data and outputting the video data to the display, thereby performing display control of the demonstration video.

The program product for causing a computer to function as the various unit of the mahjong gaming machine 10 according to the second embodiment can be applied to the computer as shown in FIG. 11 and the game system as shown in FIG. 12 like the program product for causing a computer to function as the various unit of the mahjong gaming machine 10 according to the first embodiment.

According to the embodiments described above, the demonstration video changes in accordance with the game history, so that it is possible to draw attention of persons who do not play a game, and demonstration video which is rich in surprise and can demonstrate the sufficient advertising effectiveness can be displayed. Consequently, the interest of a person who does not play a game in a game can be raised and the person can be made anxious to play a game; it is made possible to improve the pulling power of the video game arcade.

For example, if the game is a mahjong game for the player to select one from among opponent characters and play the game against the selected opponent character, demonstration video is displayed in accordance with the game history in such a manner that when the game is over after a specific opponent character has been selected a predetermined number of times, character instruction movie using a special image of the opponent character is displayed as the demonstration video, so that the player who once played a game can be made anxious to play another game for prompting the player to continue to play a game.

For another example, if the game is a mahjong game for the player to select one from among opponent characters and play the game against the selected opponent character, the demonstration video format changes in accordance with the game history in such a manner that when the game is over after a specific opponent character has been selected a predetermined number of times, the demonstration video format changes and the display portion of the profile of the opponent character in the demonstration video is replaced with character instruction movie using a special image of the opponent character, so that the player who once played a game can be made anxious to play another game for prompting the player to continue to play a game.

According to the embodiments described above, the interest of a person who does not play a game in a game can be raised and the person can be made anxious to play a game; it is made possible to improve the pulling power of the video game arcade. Since the demonstration video responsive to the game history is displayed, the player who once played a game can be made anxious to play another game for prompting the player to continue to play a game.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

1. A gaming machine comprising:
a demonstration video data storage unit that stores a plurality of demonstration video data of different types concerning demonstration video;
a game history storage unit that stores a game history;
a demonstration video data selection unit that selects at least one piece of demonstration video data from among the plurality of demonstration video data in accordance with the game history stored in the game history storage unit; and
a display control unit that controls a display device attached to the gaming machine to display the demonstration video data that is selected by the demonstration video data selection unit when no game is played by a player.

2. The gaming machine according to claim 1, wherein the demonstration video data includes at least one of a plurality of video data of a logotype of a manufacturer of the game, a title screen, a game introduction movie, a character introduction movie, a computer simulation play movie, and a score ranking of the game.

3. The gaming machine according to claim 1, wherein the demonstration video data includes a plurality of video data concatenated in a predetermined order and a predetermined time allocation.

4. The gaming machine according to claim 1, wherein the game history includes at least one of a number of times that each of opponent characters of the game has been selected, a ratio of selection for each of the opponent characters, time period of playing the game, a number of characters won by the player, a winning condition won by the player, and a game point won by the player.

5. The gaming machine according to claim 1, wherein the game history storage unit stores the game history for each of a plurality of players of the game.

6. The gaming machine according to claim 1, wherein the display control unit controls the display device to display the demonstration video data during time until the game is over is counted after the player loses the game.

7. The gaming machine according to claim 1, further comprising a selection table storage unit that stores a demonstration video data selection table that indicates correspondence between the game history and the demonstration video data to be selected,
wherein the demonstration video data selection unit selects the demonstration video data with reference to the demonstration video data selection table stored in the selection table storage unit.

8. A gaming machine comprising:
a video data storage unit that stores a plurality of video data of different types, the plurality of video data in which to be concatenated with each other to provide a demonstration video;
a game history storage unit that stores a game history;
a format data storage unit that stores a plurality of format data each indicating a format of the demonstration video;
a format data selection unit that selects at least one piece of format data from among the plurality of format data in accordance with the game history stored in the game history storage unit; and
a display control unit that replaces at least one piece of the video data that is concatenated with other pieces of the video data to form the demonstration video with another piece of the video data in accordance with the format data selected by the format data selection unit, and controls a display device attached to the gaming machine to display the demonstration video when no game is played by a player.

9. The gaming machine according to claim 8, wherein each of the plurality of video data includes at least one of a logotype of a manufacturer of the game, a title screen, a game introduction movie, a character introduction movie, a computer simulation play movie, and a score ranking of the game.

10. The gaming machine according to claim 8, wherein the demonstration video includes the plurality of video data concatenated in a predetermined order and a predetermined time allocation.

11. The gaming machine according to claim 8, wherein the game history includes at least one of a number of times that each of opponent characters of the game has been selected, a ratio of selection for each of the opponent characters, time period of playing the game, a number of characters won by the player, a winning condition won by the player, and a game point won by the player.

12. The gaming machine according to claim 8, wherein the game history storage unit stores the game history for each of a plurality of players of the game.

13. The gaming machine according to claim 8, wherein the display control unit controls the display device to display the demonstration video during time until the game is over is counted after the player loses the game.

14. The gaming machine according to claim 8, further comprising a selection table storage unit that stores a format data selection table that indicates correspondence between the game history and the format data to be selected,
wherein the format data selection unit selects the format data with reference to the format data selection table stored in the selection table storage unit.

15. A computer-readable program product for displaying demonstration video on a display device when no game is played by a player, the program product for causing a computer to execute the steps comprising:
storing a plurality of demonstration video data of different types concerning demonstration video;
storing a game history;
selecting at least one piece of demonstration video data from among the plurality of demonstration video data in accordance with the stored game history; and
controlling a display device attached to the gaming machine to display the demonstration video data that is selected when no game is played by a player.

16. The program product according to claim 15, wherein the demonstration video data includes at least one of a plurality of video data of a logotype of a manufacturer of the game, a title screen, a game introduction movie, a character introduction movie, a computer simulation play movie, and a score ranking of the game.

17. The program product according to claim 16, wherein the demonstration video data includes the plurality of video data concatenated in a predetermined order and a predetermined time allocation.

18. The program product according to claim 15, wherein the game history includes at least one of a number of times that each of opponent characters of the game has been selected, a ratio of selection for each of the opponent characters, time period of playing the game, a number of characters won by the player, a winning condition won by the player, and a game point won by the player.

19. The program product according to claim 15, wherein in storing the game history, the game history for each of a plurality of players of the game is stored.

20. The program product according to claim 15, wherein in controlling the display control unit, the display device is controlled to display the demonstration video data during time until the game is over is counted after the player loses the game.

21. The program product according to claim 15, further causing the computer to execute the step of storing a demonstration video data selection table that indicates correspondence between the game history and the demonstration video data to be selected,
wherein in selecting the demonstration video data, the demonstration video data is selected with reference to the demonstration video data selection table stored in the selection table storage unit.

22. A computer-readable program product for displaying demonstration video on a display device when no game is played by a player, the program product for causing a computer to execute the steps comprising:
storing a plurality of video data of different types, the plurality of video data in which to be concatenated with each other to provide a demonstration video;
storing a game history;
storing a plurality of format data each indicating a format of the demonstration video;
selecting at least one piece of format data from among the plurality of format data in accordance with the game history;
replacing at least one piece of the video data that is concatenated with other pieces of the video data to form the demonstration video with another piece of the video data in accordance with the selected format data; and
controlling a display device attached to the gaming machine to display the demonstration video when no game is played by a player.

23. The program product according to claim 22, wherein each of the plurality of video data includes at least one of a logotype of a manufacturer of the game, a title screen, a game introduction movie, a character introduction movie, a computer simulation play movie, and a score ranking of the game.

24. The program product according to claim 22, wherein the demonstration video includes the plurality of video data concatenated in a predetermined order and a predetermined time allocation.

25. The program product according to claim 22, wherein the game history includes at least one of a number of times that each of opponent characters of the game has been selected, a ratio of selection for each of the opponent characters, time period of playing the game, a number of characters won by the player, a winning condition won by the player, and a game point won by the player.

26. The program product according to claim 22, wherein in storing the game history, the game history for each of a plurality of players of the game is stored.

27. The program product according to claim 22, wherein in controlling the display device, the display device is controlled to display the demonstration video during time until the game is over is counted after the player loses the game.

28. The program product according to claim 22, further causing the computer to execute the step of storing a format data selection table that indicates correspondence between the game history and the format data to be selected,
wherein in selecting the format data, the format data is selected with reference to the stored format data selection table.
